(19) United States
(12) Patent Application Publication
(10) Pub. No.: US 2022/0145864 A1
(43) Pub. Date: May 12, 2022

(54) Differential gravity power generator

(71) Applicant: Soemar Emid, Wassenaar (NL)

(72) Inventor: Soemar Emid, Wassenaar (NL)

(21) Appl. No.: 17/438,476

(22) PCT Filed: Mar. 4, 2020
(86) PCT No.: PCT/NL2020/000003

§ 371 Date: Sep. 13, 2021

(30) Foreign Application Priority Data
Apr. 26, 2019 (NL) 1043242
Sep. 3, 2019 (NL) 1043369

(51) Int. Cl. F03G 7/10; F03B 17/04

(52) U.S. Cl. CPC F03G 7/104; F03B 17/04

(57) ABSTRACT

Differential gravity power generator FIG. 1 consisting of a box height H, filled with fluid, subject to gravity. The box is divided into T₁ (1, 2, 3, 4, 5, 8) and T₂ (2, 3, 5, 6, 7, 8) by plane (2, 3, 5, 8) with openings A above and B below. The difference of effective head of T₂ over T₁ is ⅓H, resulting in a fluid flow from T₂ to T₁ through B. From the continuity equation an equal quantity of fluid flows from T₁ to T₂ through A, establishing a fluid conserving motion, demonstrated with working models. Applications: electricity generation with water or other fluid like liquid CO₂ and motive purposes like propulsion of ships.

### TECHNICAL FIELD

The technical field is power generation with cycled fluid subject to gravity. The invention is a fluid conserving differential gravity power generator, which can be used for electricity generation and motive purposes like ship propulsion. Priority call on [13, 14].

### PRIOR ART

Since the middle ages people tried to build perpetual machines which would run indefinitely and deliver energy for free. Famous is Bhaskara's wheel [1], replicated and tried many times in the literature, but till now without success. Boyle's self-flowing flask [2] and its replicas are other examples of unsuccessful attempts. Genswein [3] described a cyclic fluid method to draw energy from the interaction with gravity, but the initial fluid velocity ν₀=(2gh₀)^{1/2} ([3]p. 2 lines 10-15) is wrong. It should be ν₀=(gh₀)^{1/2}, because the effective head of water in a cylinder or rectangular box of height ho is Xho, cf. Emid [4], in accordance with the theory of Malcherek [5, 6], confirmed by experiments.

A perpetual machine is impossible according to the law of energy conservation [7]. There are many patent applications claiming perpetual motion which turned out to be inoperable. The United States Patent and Trademark Office (USPTO) decided not to grant such patents without a working model [7]. Gravity power plants are proposed [8, 9] without a working model; [8, 9] are discussed in the last section.

### Description of the Inventive Steps

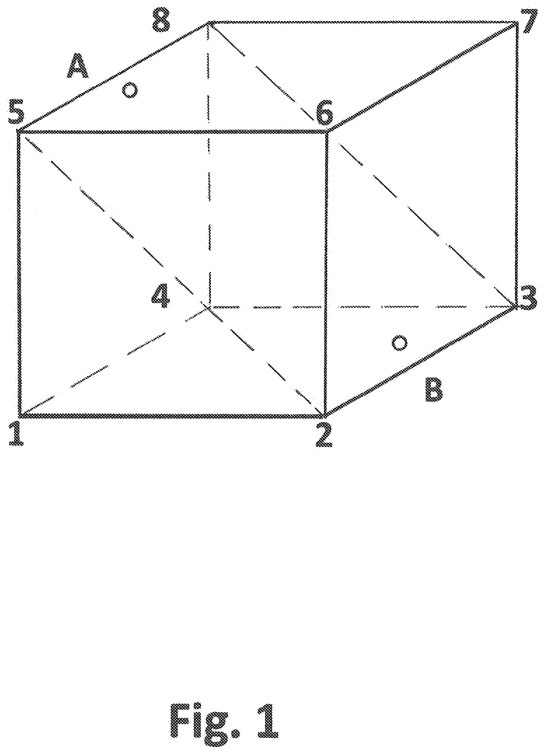

The differential gravity power generator (DGPG) is described with an exemplar FIG. 1 depicting a rectangular box with corners 1 to 4 (bottom), 5 to 8 (top), length L=distance 1-2, width W=distance 1-4 and height H=distance 1-5. H is called (gross) head. The box is divided by a slanted plane (2, 3, 5, 8) into two triangular wedges T₁ (1, 2, 3, 4, 5, 8) and T₂ (2, 3, 5, 6, 7, 8). In the slanted plane there are two openings, A above, near the surface and B below, near the bottom. The box is filled with water as non-viscous incompressible fluid. The water is, but not necessarily, under atmospheric pressure and is subject to earth's gravity with strength g=9.8 m/s², which is attractive downward.

It follows from the geometry, calculus and the definition of potential energy relative to its reference point B, cf. [4] that the effective head for T₁ is ¼H and for T₂ is ⅔H, both with respect to B. So there Is a difference of ⅓H of effective head of T₂ over T₁, causing a flow from T₂ to T₁ through B below. From the continuity equation this causes a flow of equal water quantity from T₁ to T₂ through A above. Therefore, due to the different energetic effects of the gravitational field on the top up T₁ and the top down T₂, a fluid conserving, differential gravity power generator is created. This principle can be applied to two, or more, water bodies, in various forms and configurations.

It is noted that the name “gravity power generator” in the literature applies to all hydropower plants based on hydraulic head. The addition “differential” is specific for the method. Furthermore, the water in the box is not a conservative system, as it is in interaction with the earth through the gravity. The energy within the box need not be conserved, the energy of the box+earth is conserved.

Experiments have been done with a rectangular box (of multiply concrete casing). L=W=0.18 m, H=0.6 m, slanted plane 0.18×0.62 m, diameters of A and B: 16 mm. The capacity P, net capacity Pₙ of the water and the resistance R of the embodiment are:

P=⅓QρgH,Pₙ=P−R,0<R≤P Eq. 1

with Q=π (0.008)²ν, ν²=⅔g H, ρ=10³ kg/m³, g=9.8 m/s². P=0.8 Watt. R depends on factors like roughness, size and shape of the materials, speed of water flow, length and diameter of tubes if any. Observation: Stationary state is established in 2 minutes after filling the box. A laminar flow is observed from T₁ to T₂ through gate A, with initial flow velocities of about 2 cm/s in the center of the flow, demonstrating that the model works.

In practice to harness the energy difference between T₁ and T₂, while minimizing the loss of kinetic energy, the most appropriate way is to install a bulb turbine-generator at gate B. This reaction type turbine-generator strips off the kinetic energy from the tall-water that flows into T₁ and converts it into pressure head helping to run the turbine. The flow at A becomes slow, so there is less dissipation of kinetic energy into heat.

It is noted that time evolution studies belong to relaxations studies [10], which is outside the scope of the invention, though results will be mentioned in the applications.

Some aspects of the model are mentioned here, with details in next section:

1. T₁ and T₂ need not be of the same form, nor of the same volume.
2. The capacity P can be enhanced by making B bigger, H higher and by using a solution [11]. The embodiment can be fixed above ground, dig in or submerged e. g. in natural or hydro lake. It can also be configured as ship engine. The method is fluid conserving, no need for a hydro lake or dam. It can be applied in cold climate by adding antifreeze.
3. Other fluids can be used, like liquid carbon dioxide (CO₂), enclosed and under pressure. On earth this would contribute to the solution of the CO₂ problem. On Mars with more than 95% CO₂ in its atmosphere, this would provide ample power for future Martians. Prefabricated embodiments can be sent to Mars prior to manned missions.
4. The method explains the benefit of pyramid homes.

### SHORT DESCRIPTION OF FIG. 1

FIG. 1. A box, divided into T₁(1, 2, 3, 4, 5, 8) and T₂(2, 3, 5, 6, 7, 8) by plane (2, 3, 5, 8) with openings A above and B below. Height H is distance 1-5, length L is distance 1-2 and width W is distance 1-4. The box is filled with an incompressible fluid and is subject to gravity. The difference in effective head of T₂ over T₁ is % H, resulting in a cyclic fluid motion from T₂ to T₁ through B and from T₁ to T₂ through A.

### PREFERRED APPLICATIONS

1. T₁T₂—Model as in FIG. 1 and Other Configurations.

Second example. The rectangular box is of glass (aquarium), with L=W=0.3 m, H=0.4 m, slanted plane of concrete casing 0.3×0.58 m. B: Ø 22 mm, A: Ø 12 mm. The initial flow is about 1 cm/s during 45 minutes. The long time evolution of the flow is between 2-8 mm/s with diurnal variation, experimental duration was one week.
Third example. To mimic Boyle's self-flowing flask [2], T₂: H=0.6 m, L=0.4 m, W=0.25 m and T₁: H=0.6 m, L=0.14 m and W=3.5 cm. The common plane of T₁ and T₂ is now vertical, A: Ø 8 mm, B: Ø 25 mm, distance A−B is 0.5 m. Material: concrete casing. Observation: In the stationary state the initial flow velocity is between 2-3 cm/s, largest at the center of the flow. After half an hour the flow slows down to 1-5 mm/s with diurnal variation, experimental duration: one week. This is a working Boyle's self-flowing flask [2].
Other examples are: top up cone C₁ (of height H, effective head ¼H) and top down cone C₂ (effective head ¾H), or top up pyramid P₁ (effective head ¼H) and top down pyramid P₂ (effective head ¾H) or combination thereof can be used. A cylinder or a rectangular box has an effective head % H. It follows that the effective head of a C₁C₂ or P₁P₂ combination is % H, the same [4] as for traditional (flow through) hydro power plant.

2. Capacity P for a T₁T₂ Configuration.

H=L=W, effective head ⅓H, ρ=10³ kg/m³, g=9.8 m/s², Q=B (⅔ g H)^{1/2}, choosing for B=0.09 H². The density p can be enhanced by 5 to 10 times by using a solution, see [11] for a suitable choice of solutes.

TABLE 1
Capacity P = 0.75 H^{7/2} kW, H in meter

| H (m) | P (kW) | H (m) | P (MW) |
|---|---|---|---|
| 1 | 0.75 | 10 | 2.3 |
| 2 | 8 | 20 | 26 |
| 3 | 35 | 30 | 110 |
| 4 | 96 | 40 | 300 |
| 5 | 200 | 50 | 660 |
| 6 | 400 | 60 | 1250 |
| 7 | 680 | 70 | 2150 |
| 8 | 1080 | 80 | 3430 |
| 9 | 1640 | 90 | 5180 |

For comparison: Biggest wind turbine to date is 10 MW, gas turbine 571 MW, steam turbine 1750 MW/GE Arabelle 1700 and marine engine 81 MW/Wärtsilä TRA 96 [12].

FIG. 1 can be modified for ship propulsion, with B relocated to plane (2, 3, 6, 7) just above line (2, 3) and an opening C made in plane (1, 4, 5, 8), just above line (1, 4). A remains as is. The embodiment is submerged in the ocean, which has an effective head ½H [4]. Consequently, water flows from T₂ to the ocean through opening B, overhead ¼H, from the ocean to T₁ through opening C, overhead ⅙H, and from T₁ through opening A to T₂ at the same water level. The total thrust is ⅓H, so Table 1 can also be used for the capacity of this ship engine. The smallest ship engine would be just T₂ with overhead of % H over the ocean water and can serve as bow thruster. For the propulsion of big tankers like Emma Mærsk (12) 111 MW is needed. A series of T % T₂ pairs can be used to keep H within acceptable values, see table 1.

3. Use of other fluids, like liquid CO₂ at temperatures >−55° C. For suitable pressures see the phase diagram of CO₂ in the literature. The Importance for application on earth and on Mars is already mentioned in the description.

4. The beneficial effect of pyramid home, height H, is due to the difference of the effective air head of the surroundings (½H) and the effective air head in the top up pyramid (¼H). The differential head is ¼H. The density of air is 800 times smaller than that of water. The capacity Pₐᵢᵣ=0.6 H^{7/2} Watt. For H=10 m Pₐᵢᵣ=1.9 kW, for H=15 m Pₐᵢᵣ=7.8 kW for quiet fresh air circulation through the pyramid home, contributing to the ambient comfort. This occurs even during wind stillness.

### Discussion

Assad mentioned [8] p. 2 “How invention works: The water fall from valve under tank and make shield motion”. At end of p. 2: “Water Return Rising by one way valves and by inversing Power with shield”. Comment: 1. One-way valves do not rise the water, only prevent back flow. 2. “The shield is moved by the falling water, then inversely the shield motion is used to rise the water”. Comment: Even if it works this kind of pump storage method costs more energy than it produces and it is not used in the application.

Moncada Rodriguez, in [9] p. 6 claim 1 lines 2-18, used a cylindrical tank, with conical bottom, as hydraulic head, connected to a U shaped tube, one end at tank bottom, other end at the side inlet at the water level of the tank. Comment:1. Effective head of a cylinder is the same as that of the small tube aside the cylinder, so there will be no flow (communicating vessels with equal effective heads). 2. FIG. 4—Section 3 p. 6 lines 37-42: a second propeller in the left leg of the U-tube rotates an Interconnecting cable to drive the impeller to pump the water back in the tank. Comment: This is a kind of pump storage that is not used in the application.

It is emphasized that the comments do not questioned the validity of the inventions [8, 9], but only point out the different methods they used, which are not borrowed by the application. It is concluded that [8, 9] are not relevant prior arts for the present invention.

### NOTE Related to the Written Opinion of the International Search Report SN73827

No change needs to be made in the text of the application, as justified below. ItemV1, 1.1 D1(US20130062887A1), D2(WO2010017607A2+A3), D3(WO2004094816 A1)

The written opinion is wrong, as the embodiment is in interaction (strength P, Eq. 1) with earth. It is not an isolated system, see page 2 lines 11-13. The first law of Thermodynamics, stating that the energy of an isolated system is constant, does not apply to the case. Consequently, the written opinion item V 1 and 1.1 should be rejected as being mistaken and invalid comments. Moreover, the last sentence in item V 1.1 incorrectly cites: “continuous” which is not present in the cited page 3 lines 17-18.

Item V 2: D1, 2 and D3 compared to D4 (application). Capacity: P−QρgH: D1: Inventive step is changing g at different parts of the water, by diffraction of presumed outgoing earth's gravity wave. There is no cross-reference (cf. D1) validating the assumption. But even if such a wave (by static earth) would exist, then still the inventive step of D1 differs from that in D4. D4 creates different effective heads, ⅓H in T₁ and ⅔H in T₂, page 2 lines 1-8.

D2: Its international search report states: “no meaningful international search can be carried out”. However, FIGS. 1-3 can be recognized as communicating vessels V1(1) and V2(7+vertical part of 3), connected below by the horizontal pipe with valve 5 and turbine 6, above connected with 180° bend of (3) providing equal air pressure of unknown X atm. on V1 and V2. As the effective head of box V1 or cylinder V2 is % height, cf. D4 page 2. lines 15-16 and [4-6], so after opening of valve 5 the motion will stop at equal water level in V1 and V2, as is well known. Whereas in D4 water flows from T₁ through A to T₂ for some time, as reported on page 2 lines 22-24 and page 3 lines 21-31.
D3 is already discussed on page 5 lines 15-20. That position is maintained.
Working models: D1, D2 and D3: None. D4: Yes, several.

Finally: As test of the smallest ship engine, page 4 line 31, experiments were done with a funnel as C₂, page 4 line 1 and 2. At water level: Inlets 2×7 Ø 2 cm (with momentum compensation). Horizontal outlet Ø12 mm below in funnel shaft, opening of shaft end is taped off. Funnel height 18 cm, opening Ø=28 cm, material: plastic (floats in water). Observation: Funnel moves in opposite direction as the outlet, which is proof of concept.

### Remark Regarding Gravitational Waves

With regard to the assumption of gravitational waves in D1, page 6 lines 4, 11-16, experts stated that gravitational waves of the earth is far too small to be measureable with existing instruments, see e.g. [15]. The earth lacks of mass and acceleration/spinning rate to create gravitational waves. Therefore, the assumption makes no sense at all.

### REFERENCES

[1] Bhaskara II (1150), https://en.wlkipedia.org/wiki/Bhaskara's wheel.
[2] Boyle's self-flowing flask (1685), https://en.wikipedia.org/wiki/Robert Boyle.
[3] Genswein A., Kreisprozess zur Gewinnung technischer Arbeit aus dem Schwerkraftfeld (Gravitationsfeld) der Erde, DE 3716093 A1, 28 Jan. 1988.
[4] Emid S., High capacity factor hydro power plant with variable intake, NL 1041539, application Oct. 20, 2015, publication date 10 May 2017.
[5] Malcherek A., History of the Torricelli Principle and a New Outflow Theory, J. Hydraul. Eng. 2016,142(11), 1-7.
[6] Malcherek A., Die irrtümliche Herleitung der Torricelli-Formel aus der Bernoulli-Gleichung, WasserWirtschaft 2/3 (2016) 75-80.
[7] https://en.wikipedia.org/wiki/Perpetual motion.
[8] Assad, Beshara, Plant for generation of electricity from force of gravity, WO 2004/094816 A1, 4 Nov. 2004.
[9] Moncada Rodriguez O. E., Water gravity loop power plant (WGLPP) U.S. Pat. No. 9,677,536 B2, 13 Jun. 2017.
[10] Redfield A. G., https://en.wikipedia.org/wiki/Redfield equation.
[11] https://en.wikipedia.org/wiki/Solubility table.
[12] https://en.wikipedia.org/wiki/Emma Maersk
[13] S. Emid, Differential gravity power generator, NL 1043242, application date 26 Apr. 2019, of which this PCT application is a faithful copy. Priority call 1.
[14] S. Emid, Carbon dioxide power generation, NL 1043369, application date 18 Sep. 2019. Priority call 2.
[15] Sources and Types of Gravitational Waves, ligo.caltech.edu/page/gw-sources.

1. Gravity power generator, characterized by two containers 1 and 2 of equal height and known geometry, like a triangular wedge, cone or pyramid, filled with incompressible fluid and subject to a downward attractive gravity field. The centers of gravity of the fluids in 1 and 2 are known from geometry. The orientation of 1 is top-up; that of 2 is top-down. Consequently the potential energy density of the fluid in 1 is smaller than in 2, by a known amount. By connecting 1 and 2 with a gate A above and with another gate B below, fluid flows from 2 through B into 1. By mass conservation an equal amount of fluid flows back from 1 through A to 2, thus creating a gravity driven power generator, with cyclic fluid. Dissipative losses of the embodiment can be taken into account in the capacity factor.

2. Method according to claim 1, applied for the generation of electricity, in a fixed embodiment either above ground or dig in, or in a floating embodiment, with a reaction type turbine-generator, installed in the gate B below between the containers.

3. Method according to claims 1 and 2 in a floating embodiment, applied in configurations suitable for the propulsion of ships, for the main propulsion as well as for auxiliaries, like to serve as bow thruster.

4. Method according to claims 1 and 2 with water as fluid, with antifreeze added for application in cold climate.

5. Method according to claim 4 with water as fluid, to which a solute is added to enhance the density of the solution.

6. Method according to claims 1 and 2, with CO₂ fluid in closed containers, at suitable temperature and pressure.

7. Method according to claim 1, applied to air at atmospheric pressure, for the calculation of the natural ventilation capacity of buildings, in particular of pyramid homes.

8. Method according to claims 1 and 2, characterized by the application of a temperature gradient across a temperature region containing the critical temperature of the fluid where the density changes with temperature are large, in such a way that the density of the fluid flowing through gate B into container 1 becomes much smaller than the average density of the fluid in the containers 1 and 2. Consequently the float up of the lighter fluid that passes through gate B into container 1 will be stimulated by the higher buoyancy of the surrounding heavier fluid in 1.
